(19) United States
(12) Patent Application Publication
(10) Pub. No.: US 2020/0142374 A1
(43) Pub. Date: May 7, 2020

(54) UNIVERSAL SELF LEARNING AND ADAPTABLE LEVEL SENSORS FOR RESTROOM DISPENSERS

(71) Applicant: GOJO Industries, Inc., Akron, OH (US)

(72) Inventor: Jackson W. Wegelin, Stow, OH (US)

(21) Appl. No.: 16/672,806

(22) Filed: Nov. 4, 2019

Related U.S. Application Data
(60) Provisional application No. 62/754,612, filed on Nov. 2, 2018.

(51) Int. Cl. G05B 19/042; A47K 5/12; G06Q 10/06; G01F 25/00; G05B 15/02; A47K 10/32

(52) U.S. Cl. CPC G05B 19/0425; A47K 5/1217; G06Q 10/06315; A47K 2010/3226; G05B 15/02; A47K 10/32; G05B 2219/2642; G01F 25/00

(57) ABSTRACT

Self-calibrating level sensors for dispensers, receptacles and restroom systems. A restroom system includes a first product dispenser for dispensing a first product, a second product dispenser for dispensing a second product, wherein the first product is different than the second product. A first self-calibrating level sensor is located in the first dispenser and includes a housing, a transmitter, a receiver, a processor and memory. The sensor includes logic for causing transmitting and receiving level signals, logic for assigning a first level as an empty level and for assigning a second level as a full level, logic for assigning a third level as the empty level if the third level is less than the first level, and logic for assigning a fourth level as the full level if the forth level is greater than the second level. A second self-calibrating level sensor is located in the second dispenser.

### RELATED APPLICATIONS

The present invention claims the benefits of, and priority to, U.S. Provisional Application Ser. No. 62/754,612 titled UNIVERSAL SELF LEARNING AND ADAPTABLE LEVEL SENSORS FOR RESTROOM DISPENSERS, which was filed on Nov. 2, 2018, and which is incorporated herein by reference in its entirety.

### TECHNICAL FIELD

The present invention relates generally to product level sensors for dispensing systems and more particularly to universal self-learning and adaptable level sensors for restroom dispensers.

### BACKGROUND

Restrooms often contain a number of different dispensers, such as, for example, paper towel dispensers, toilet paper dispensers, soap and sanitizer dispensers and the like. There are many different manufactures for these dispensers and many manufactures offer many different dispenser models within the dispenser lines. If these dispensers are equipped with level sensors, each of the level sensors are usually customized for the particular type of dispenser and may also have customized means for communicating the particular level. In addition, these different level sensors may require different calibration techniques. In addition, it is difficult to retrofit a bunch of different existing dispensers with level sensors and calibrate those level sensors due to existing physical constraints, such as, for example, random housing sizes and the inability to be able to access the level sensors once installed and product is loaded into the dispensers.

### SUMMARY

Exemplary self-calibrating level sensors for dispensers and receptacles and restroom systems including such level sensors are disclosed herein. An exemplary restroom system includes a first product dispenser for dispensing a first product, a second product dispenser for dispensing a second product, wherein the first product is different than the second product. A first self-calibrating level sensor is located in the first dispenser. The first self-calibrating level sensor includes a housing, a transmitter, a receiver, a processor and memory. The self-calibrating level sensor further includes logic for causing the transmitter to transmit, and the receiver to receive, signals indicative of a plurality of levels of product in a dispenser, logic for assigning a first level as an empty level, logic for assigning a second level as a full level, logic for assigning a third level as the empty level if the third level is less than the first level, and logic for assigning a fourth level as the full level if the forth level is greater than the second level. The restroom system further includes a second self-calibrating level sensor in the second dispenser. The second self-calibrating level sensor comprises the components identified above with respect to the first self-calibrating sensor.

An exemplary self-calibrating level sensor for a dispenser or receptacle includes a housing, a transmitter, a receiver, a processor, and memory. The self-calibrating level sensor further includes logic for causing the transmitter to transmit, and the receiver to receive, signals indicative of a plurality of levels of product in a dispenser, logic for assigning a first level as an empty level, logic for assigning a second level as a full level, logic for assigning a third level as the empty level if the third level is less than the first level, and logic for assigning a fourth level as the full level if the forth level is greater than the second level.

Another exemplary self-calibrating level sensor for a dispenser or receptacle includes a housing, a transmitter, a receiver, a processor and memory. The self-calibrating level sensor further includes logic for causing the transmitter to transmit, and the receiver to receive, signals indicative of a plurality of levels of product in a dispenser, logic for assigning a first level as an empty level, logic for assigning a second level as a full level, logic for assigning a third level as the empty level if the third level is less than the first level, and logic for assigning a fourth level as the full level if the forth level is greater than the second level. In addition, the self-calibrating level sensor also includes wireless communication circuitry for transmitting a signal indicative of a level of product in the dispenser.

### BRIEF DESCRIPTION OF THE DRAWINGS

FIG. 1 is a schematic view of an exemplary restroom having a plurality of different types of dispensers having exemplary self-learning level-sensors;

FIGS. 2A and 2B are simplified cross-sectional views of an exemplary folded paper towel dispenser having an exemplary self-learning level-sensor;

FIGS. 3A and 3B are simplified cross-sectional views of an exemplary toilet paper dispenser or a rolled paper towel dispenser having an exemplary self-learning level-sensor;

FIGS. 4A and 4B are simplified cross-sectional views of an exemplary waste receptacle having an exemplary self-learning level-sensor;

FIG. 5 is a schematic block diagram of an exemplary self-learning level-sensor;

FIG. 6 is an exemplary flow chart for a methodology for installing a level dispenser in a dispenser/receptacle

FIG. 7 is an exemplary flow diagram of calibration logic for an exemplary self-learning level-sensor; and

FIG. 8 is another exemplary flow diagram of calibration logic for an exemplary self-learning level-sensor;

FIG. 9 is a schematic diagram of another exemplary self-learning level-sensor and FIGS. 9A-9C are enlarged portions of the schematic diagram of FIG. 9.

### DETAILED DESCRIPTION

The Detailed Description describes exemplary embodiments of the invention and is not intended to limit the scope of the claims in any way. Indeed, the invention is broader than and unlimited by the exemplary embodiments, and the terms used in the claims have their full ordinary meaning, unless noted otherwise. Moreover, features and components of one exemplary embodiment may be incorporated into the other exemplary embodiments. Inventions within the scope of this application may include additional features than those shown and described, or may have less features than those shown and described in the exemplary embodiments.

“Circuit communication” as used herein indicates a communicative relationship between devices. Direct electrical, electromagnetic and optical connections and indirect electrical, electromagnetic and optical connections are examples of circuit communication. Two devices are in circuit communication if a signal from one is received by the other, regardless of whether the signal is modified by some other device. For example, two devices separated by one or more of the following—amplifiers, filters, transformers, optoisolators, digital or analog buffers, analog integrators, other electronic circuitry, fiber optic transceivers or satellites—are in circuit communication if a signal from one is communicated to the other, even though the signal is modified by the intermediate device(s). As another example, an electromagnetic sensor is in circuit communication with a signal if it receives electromagnetic radiation from the signal. As a final example, two devices not directly connected to each other, but both capable of interfacing with a third device, such as, for example, a CPU, are in circuit communication. Circuit communication includes providing power to one or more devices. For example, a processor may be in circuit communication with one or more batteries, indicating that the batteries provide power to the processor.

Also, as used herein, voltages and values representing digitized voltages are considered to be equivalent for the purposes of this application, and thus the term “voltage” as used herein refers to either a signal, or a value in a processor representing a signal, or a value in a processor determined from a value representing a signal.

“Signal”, as used herein includes, but is not limited to one or more electrical signals, power signals, analog or digital signals, one or more computer instructions, a bit or bit stream, or the like.

“Logic,” synonymous with “circuit” as used herein includes, but is not limited to hardware, firmware, software and/or combinations of each to perform a function(s) or an action(s). For example, people counter based on a desired application or needs, logic may include a software controlled microprocessor or microcontroller, discrete logic, such as an application specific integrated circuit (ASIC) or other programmed logic device. Logic may also be fully embodied as software. The circuits identified and described herein may have many different configurations to perform the desired functions.

Any values identified in the detailed description are exemplary and they are determined as needed for a particular dispenser and/or refill design. Accordingly, the inventive concepts disclosed and claimed herein are not limited to the particular values or ranges of values used to describe the embodiments disclosed herein.

Exemplary methodologies and logic flow diagrams may be described with respect to blocks or steps. The exemplary methodologies and logic flow diagrams may include additional blocks or steps, or fewer blocks or steps. In addition, blocks or steps from one exemplary embodiment, may be incorporated into other exemplary methodologies or logic flow diagrams. In addition, the steps or blocks may be performed in different orders and, thus, need not be performed in the order illustrated.

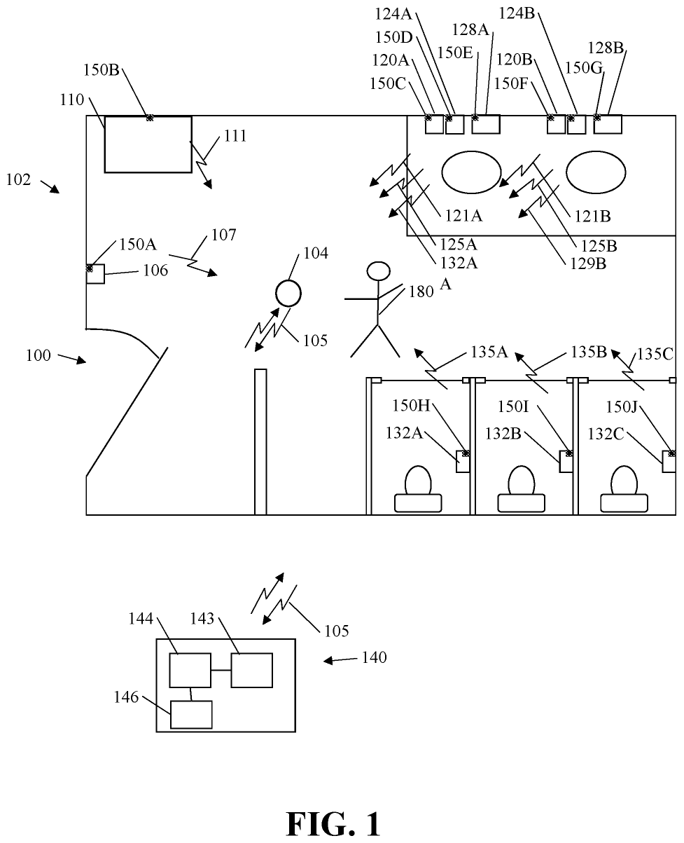

FIG. 1 illustrates an exemplary embodiment of a restroom system 100 having a plurality dispensing systems 106, 110, 128, 120B, 124A, 124P, 128A, 128B, 132A, 132B, and 132C, that include inventive level sensors 150A, 150B, 150C, 150D, 150E, 150F, 150 G, 150H, 150I and 150J. The exemplary system 100 is shown and described as a restroom 102. Restroom 102 includes a plurality of sensors that indicate fill level or product level for the dispensers or consumable products, and, in some embodiments fill level on waste receptacles. In some embodiments, only some of the dispensers or consumable products have level sensors that indicate fill level or product depletion.

In this exemplary embodiment, restroom 102 includes: a communications gateway 104; a sanitizer dispenser 106 that includes a first level sensor 150A and may have a transmitter or transceiver (not shown) associated therewith; a waste receptacle 110 that includes a second level sensor 150B, and may have a transmitter or transceiver (not shown) associated therewith; a plurality of soap dispensers 120A, 120B that include a third and fourth level sensors 150C and 150D and may have optional transmitters or transceivers (not shown) associated therewith; a plurality of lotion dispensers 124A, 124B that include a fifth and sixth level sensors 150E and 150F and may have optional transmitters or transceivers (not shown) associated therewith; a plurality of paper towel dispensers 128A that include a seventh and eighth level sensor 150G and 150H and may have optional transmitters or transceivers (not shown) associated therewith; a plurality of toilet paper dispensers 132A, 132B, 132C that include a ninth, tenth and eleventh level sensor 150I, 150J and 150K and may have optional transmitters or transceivers (not shown) associated therewith that may have transmitters or transceivers (not shown) associated therewith.

Even though the soap dispensers 120A, B, sanitizer dispenser 106, lotion dispensers 124 A, B, toilet paper dispensers 132 A, B, C, and waste receptacle 110 have different shapes and forms and contain different products, level sensors 150A, 150B, 150C, 150D, 150E, 150F, 150 G, 150H, 150I and 150J may be all the same type make and model of level sensor. Because the level sensors of FIG. 1 are all the same type of level sensor, these level sensors are referred to as level sensor 150 unless they are associated with a particular dispenser or receptacle and then may include the alphabetical suffix. Similarly, other items identified above having different alphabetical suffixes are similar items and may be referred to herein without the alphabetical suffixes.

When equipped with transmitters (not shown), the dispensers/receptacles may transmit wirelessly signals to gateway 104, and these signals may be transmitted to a master station 140 via wireless signals 105. For example, sanitizing dispenser 106 transmits signal 107, waste receptacle 110 transmits signal 111, soap dispenser 120A transmits signal 121A, lotion dispenser number 124A transmits signal 125A, paper towel dispenser 128A transmits signal 129A, soap dispenser 120B transmits signal 121B, lotion dispenser number 124B transmits signal a 125B, paper towel dispenser 128B transmits signal 129B to gateway 104 and the data is sent to master station 140 via signals 105. In this exemplary embodiment, the signals include at least one bit of data that is indicative of an amount of product in the dispenser/receptacle. The transmitted signals may also include information indicative of the identity of the dispenser or receptacle so that the master station may correlate the levels of product with the dispenser receptacle. Signals 105 are preferably wireless communication signals, however in some embodiments they may be transmitted over other means such as for example ethernet, cellular signals, or the like.

Master station 140 includes a transceiver 143 processor 144 and display 146. As with communications gateway 104, master station 140 may include a modem (not shown), an Ethernet connection (not shown), or the like for communicating with communications gateway 104.

Sanitizing dispenser 106, soap dispensers 120A, 120B and lotion dispensers 124A, 124B may be any type of dispensers such as, for example, touch-free dispensers or manual dispensers. Exemplary touch-fee dispensers are shown and described in U.S. Pat. No. 7,837,066 titled Electronically Keyed Dispensing System And Related Methods Utilizing Near Field Response; U.S. Pat. No. 9,172,266 title Power Systems For Touch-Free Dispensers and Refill Units Containing a Power Source; U.S. Pat. No. 7,909,209 titled Apparatus for Hands-Free Dispensing of a Measured Quantity of Material; U.S. Pat. No. 7,611,030 titled Apparatus for Hands-Free Dispensing of a Measured Quantity of Material; U.S. Pat. No. 7,621,426 titled Electronically Keyed Dispensing Systems and Related Methods Utilizing Near Field Response; and U.S. Pat. No. 8,960,498 titled Touch-Free Dispenser with Single Cell Operation and Battery Banking; all which are incorporated herein by reference.

Paper towel dispensers 128 may be any type of paper towel dispensers, such as for example, roll dispensers, folded paper towel dispensers and the like. Similarly, toilet paper dispensers 132 may be any type of toilet paper dispensers.

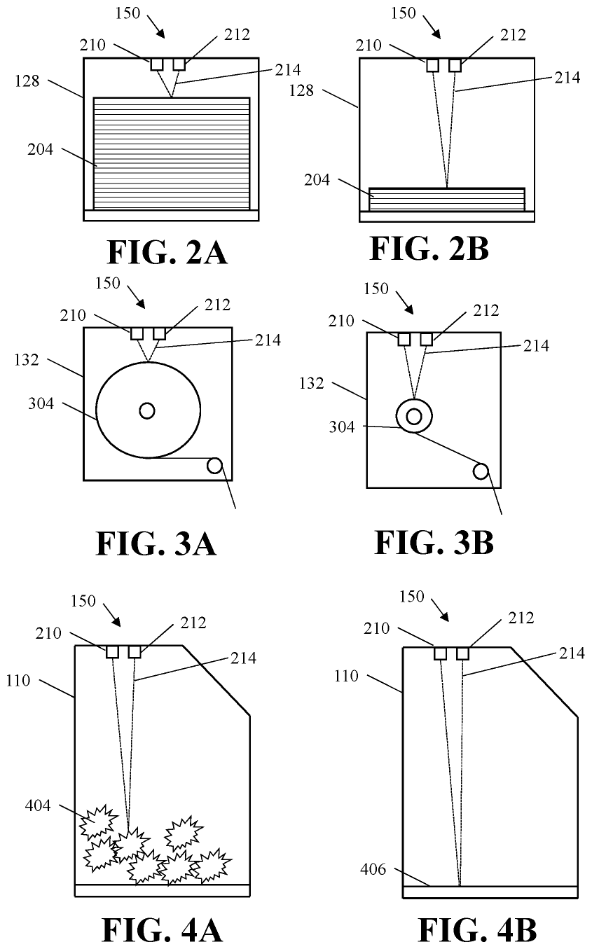

FIGS. 2A and 2B are cross-sectional views of an exemplary paper towel dispenser 128. Paper towel dispenser 128 include level sensor 150. Level sensor 150 includes a transmitter 210 and receiver 212. Transmitter 210 transmits a signal 214 which is reflected off of the paper towels 204 and is picked up by receiver 212. Level sensor 150 utilizes the received signal 214 to determine the level of paper towels 204 and dispenser 128.

FIGS. 3A and 3B are cross-sectional views of exemplary toilet paper dispensers 132. Toilet paper dispensers 132 include level sensor 150. Level sensor 150 includes a transmitter 210 and receiver 212 transmitter 210 transmits a signal 214 which is reflected off of the roll of toilet paper 304 and picked up by receiver 212. Level sensor 150 utilizes the received signal 214 to determine the level or amount of toilet paper 304 in dispenser 132.

FIGS. 4A and 4B are cross sections of exemplary waste receptacles 110. Waste receptacles 110 include level sensor 150. Level sensor 150 includes a transmitter 210 and receiver 212 transmitter 210 transmits a signal 214 which is reflected off of the surface of waste 404, or surface 406, and signal 214 is picked up by receiver 212. Level sensor 150 utilizes the received signal 214 to determine the level of waste 404 in receptacle 110.

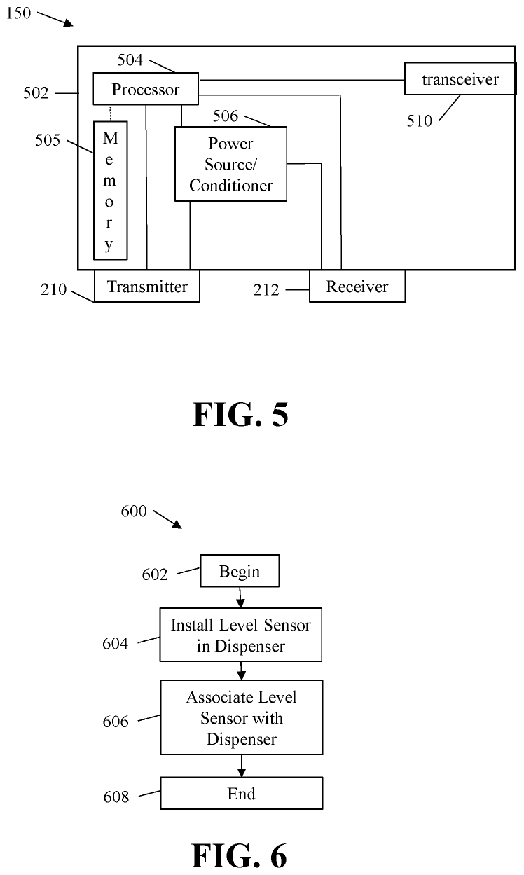

FIG. 5 is a high-level schematic block diagram illustrating an exemplary embodiment of a level sensor 150. Level sensor 150 includes a housing 502, a processor 504 in circuit communication with memory 505, a signal transmitter 210, a signal receiver 212, power source 506, conditioning circuitry 506, and an optional transmitter or transceiver 510.

Processor 504 may be any type of processor, such as, for example, a microprocessor or microcontroller, discrete logic, such as an application specific integrated circuit (ASIC), other programmed logic device or the like. Depending on the need, memory 505 may be any type of memory, such as, for example, Random Access Memory (RAM); Read Only Memory (ROM); programmable read-only memory (PROM), electrically programmable read-only memory (EPROM), electrically erasable programmable read-only memory (EEPROM), flash, magnetic disk or tape, optically readable mediums including CD-ROM and DVD-ROM, or the like, or combinations of different types of memory. In some embodiments, the memory 505 is separate from the processor 504, and in some embodiments, the memory 505 resides on or within processor 504.

Power source 506 is in circuit communications with the associated circuitry for providing power as needed. In some embodiments, a voltage regulator (not shown) is used to condition the power supplied by power source 506. Power source 506 may be any type of power source, such as, for example, one or more batteries, line voltage, solar cells, or the like. Typically, power source 506 includes one or more batteries. In some embodiments, a power source is not needed and the circuitry is powered through existing power sources in the dispensers/receptacles.

Optional, transmitter/transceiver 510 may use radio frequency (RF), infrared (IR), Bluetooth, Wi-Fi, optical coupling or the like. In addition, the transmitter/receiver may use any communication protocol. In some embodiments, multiple level sensors may be paired with one another to prevent confusions between multiple systems located in near proximity of one another. The dispensers/receptacles with level sensors may be grouped into relevant systems. In addition, in some embodiments, the level sensors in the dispensers/receptacles may be connected to one another through one or more cables, i.e. “hardwired.” In some embodiments, the level sensors 150 include an optional display (not shown) for locally displaying a level. In some embodiments, the level sensor 150 includes both a local display and an optional transceiver.

In some embodiments the transmitter 210 is an infrared (IR) transmitter and receiver 210 is IR transmitter. However, any type of transmitter/receiver combinations may be used, such as, for example, an ultrasonic transmitter/receiver, provided that the sensor is capable of accurately measuring the distance to the consumable product.

In some embodiments level sensor 150 is installed in a dispenser and the maximum and minimum levels are set during installation. In some embodiments, the dispenser minimum is set by removing all the product and initiating the “minimum level” set protocol. Then the dispenser is filled with product in the “maximum level” protocol is initiated.

In some embodiments, level sensor 150 is a self-learning level sensor that is configured to determine a “product full” level and a “product empty” level. As described in more detail below, in some embodiments, as product is added to the dispenser, the self-learning level sensor determines if the level product is at, above, or below, a prior “high-level” reading. If the product level is at a prior high-level reading, self-learning level sensor determines that the dispensers full and does not recalibrate. If the product level is below a prior high-level reading, self-learning level sensor determines that the dispenser is not full and does not recalibrate. If the product level is above a prior high-level reading, self-learning level sensor recalibrates its high-level reading to coincide with this new product level. Accordingly, each time the product level is above a prior high reading level, the self-learning level sensor recalibrate its high-level reading to correspond with the “dispenser full” level. In some embodiments, the self-learning level sensor recalibrates its prior high-level reading after a period of time if the prior high-level reading is not met during that selected period of time. Thus, if a user overfilled the dispenser one-time, the self-learning level sensor does not continue to use the “over full” product level as its full product level.

In the same manner, self-learning level sensor 150 may self-determine and calibrate the dispenser's “empty level”. Each time the self-learning level sensor 150 determines that the product level is below a previously determined low product level, the self-learning level sensor recalibrates and uses this new product level as the “empty level”.

One advantage of the inventive self-learning or self-calibrating level sensor is that a user may simply install the self-learning level sensors in multiple dispensers, having different sizes and shapes, that contain different products, and the self-learning level sensor will automatically determine the dispenser's “full” and “empty” level over a period of time. This eliminates the need to access the level sensor both when the dispenser is empty to calibrate its empty product level and when the dispenser is full to calibrate its full product level. In addition, automatic recalibration ensures that the level sensor accurately determines the product full level and product empty level throughout the life of the sensor thereby accounting for sensor drift. In addition, in some exemplary embodiments, this results in a higher level of accuracy allows a user to determine the amount of product remaining in the dispenser/receptacle with more certainty.

Although the self-learning level sensor has been described with respect to dispensers with products that are consumed, the same principle applies to the waste receptacles and the level sensors which may be used to self-determine or self-calibrate the waste receptacle full level and waste receptacle empty level in any desired level therebetween.

The exemplary methodologies disclosed herein do not limit the invention. The blocks disclosed herein may be performed in any suitable order. Moreover, additional blocks or steps may be used or required. Similarly, not all of the blocks may be needed for some embodiments and accordingly, fewer blocks may be utilized in practice. FIG. 6 is an exemplary methodology 600 for installing the inventive level sensors in a dispenser or receptacle. The exemplary methodology begins at block 602 and at block 604 the level sensor is installed in the dispenser or receptacle. At block 606 the level sensor is associated with the dispenser or receptacle. In some embodiments, associating the level sensor with the dispenser or receptacle includes linking a unique identifier, such as, for example, a serial number with the dispenser/receptacle location and/or a unique identifier of the dispenser/receptacle. The exemplary methodology ends at block 608.

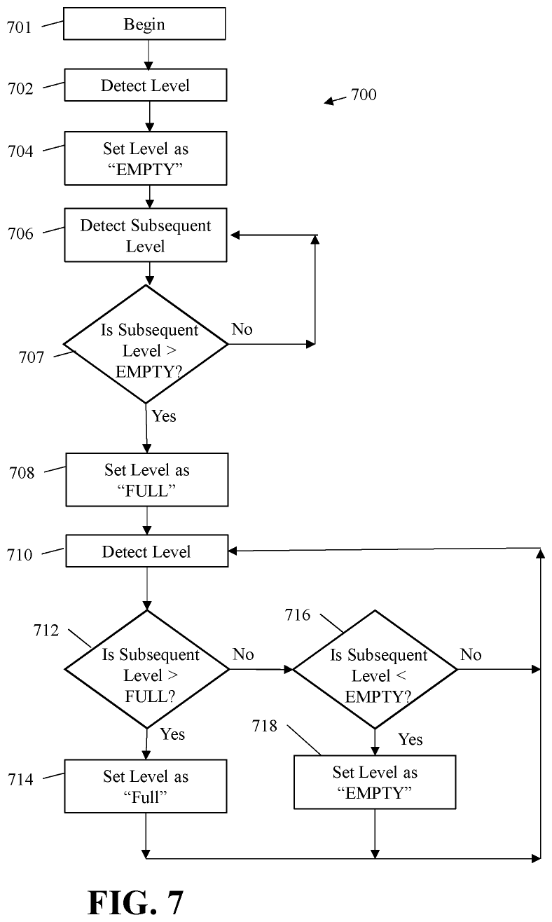

FIG. 7 is an exemplary flow diagram of a methodology for calibration logic 700 for an exemplary self-learning level-sensor. The exemplary self-learning sensor detects a first level at block 702 and sets that level or value as the “Empty Level” level at block 704. At block 706 a subsequent level is determined. At block 707, a determination is made as to whether the subsequent level is greater than the “Empty Level” level. If the subsequent level is not greater than the “Empty Level” level, the exemplary methodology flows back to block 706. If the subsequent level is greater than the “Empty Level” level, the subsequent level is set as the “Full Level” level. As indicated above, the order and flow of the logic diagram need not be as described herein. Indeed, the “Full Level” may be set first and the “Empty Level” may be subsequently set.

At block 710 a subsequent level of the product is detected. At block 712, a determination is made as to whether the level is greater than the currently set “Full Level” level. If it is, the new value of the level is set as the “Full Level” level and the methodology loops back to block 710. If at block 712 the subsequent level is less than the “Full Level” level, a determination is made at block 716 as to whether the subsequent level is less than the “Empty Level” level. If it is, the new value of the level is set as the “Empty Level” level at bock 718 and the methodology loops back to block 710. If the subsequent level is not less than the “Empty Level” level, the methodology loops back to block 710.

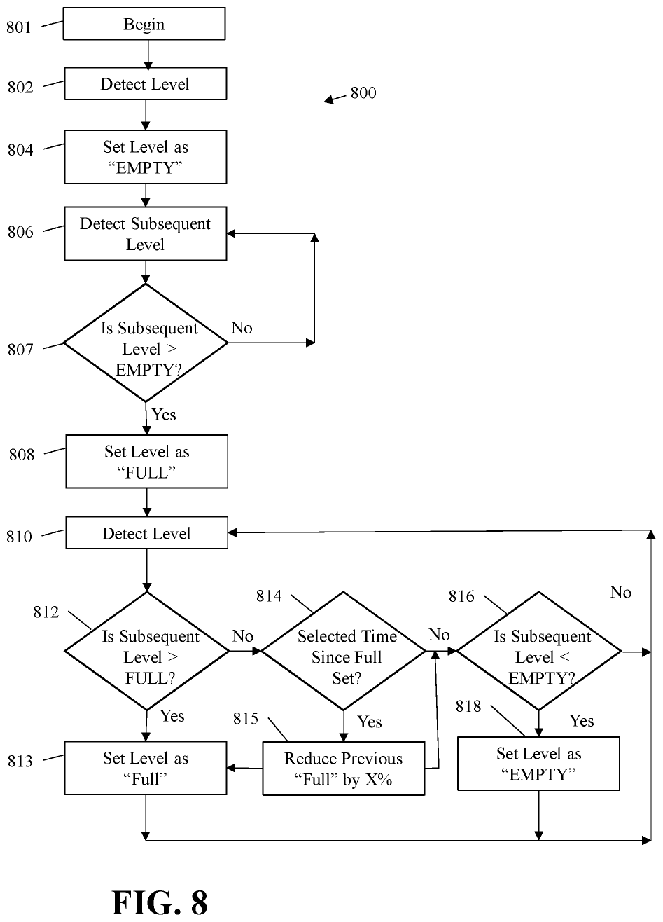

FIG. 8 is another exemplary flow diagram of a methodology for calibration logic 800 for an exemplary self-learning level-sensor. The exemplary self-learning sensor detects a first level at block 802 and sets that level or value as the “Empty Level” level at block 804. At block 806 a subsequent level is determined. At block 807, a determination is made as to whether the subsequent level is greater than the “Empty Level” level. If the subsequent level is not greater than the “Empty Level” level, the exemplary methodology flows back to block 806. If the subsequent level is greater than the “Empty Level” level, the subsequent level is set as the “Full Level” level at block 808. As indicated above, the order and flow of the logic diagram need not be as described herein. Indeed, the “Full Level” may be set first and the “Empty Level” may be subsequently set.

At block 810 a subsequent level of the product is detected. At block 812, a determination is made as to whether the level is greater than the currently set “Full Level” level. If it is, the new value of the level is set as the “Full Level” level at block 813 and the methodology loops back to block 810. If at block 812 the subsequent level is less than the “Full Level” level, a determination is made at block 814 as to whether a selected time since the “Full Level” level has been set or matched. In some embodiments, the term “matched” means matched within 5% of a previous “Full Level” level. In some embodiments, the selected time period is a function of the projected use of a dispenser. In some embodiments, the selected time period is determined as a function of actual use of a dispenser. In some embodiment, the selected time period is based on historical data. In some embodiments, the selected time period is in months, weeks or days. If the time since the last “Full Level” level has been set or matched is exceeded, the value of the “Full Level” is reduced by a selected percentage at block 815. In some embodiments, the selected percentage is less than 10%, including, for example, 9%, 8%, 7%, 6%, 5%, 4%, 3%, 2%, or 1%. The exemplary methodology flows to block 816 for a determination as to whether the subsequent level is less than the “Empty Level” level. If it is, the new value of the level is set as the “Empty Level” level at bock 818 and the methodology loops back to block 810. If the subsequent level is not less than the “Empty Level” level, the methodology loops back to block 810.

In some embodiments, the “Empty Level” does not necessarily mean that the dispenser is empty. In some embodiments, the empty level may be a level that allows time for a user to refill the dispenser. Accordingly, in some embodiments, the “empty level” may be set at a percent empty, such as, for example, 90% empty.

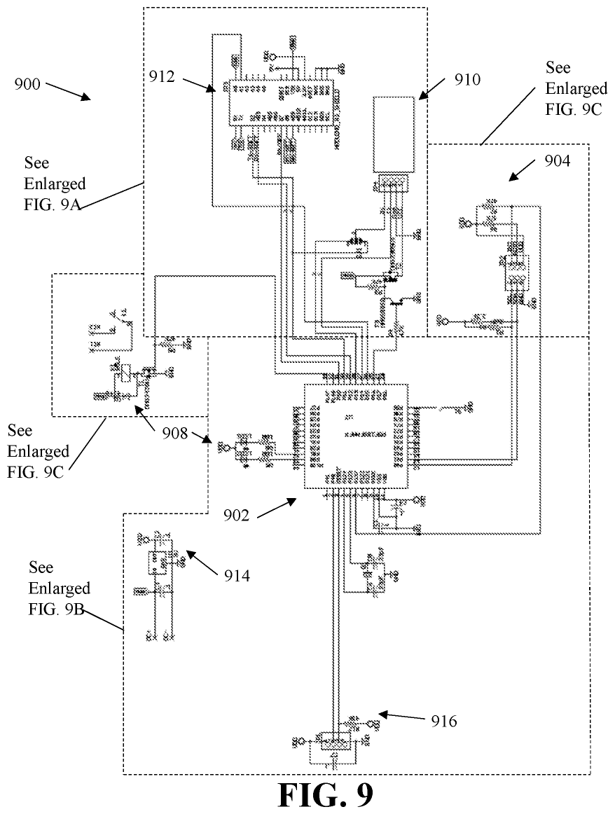

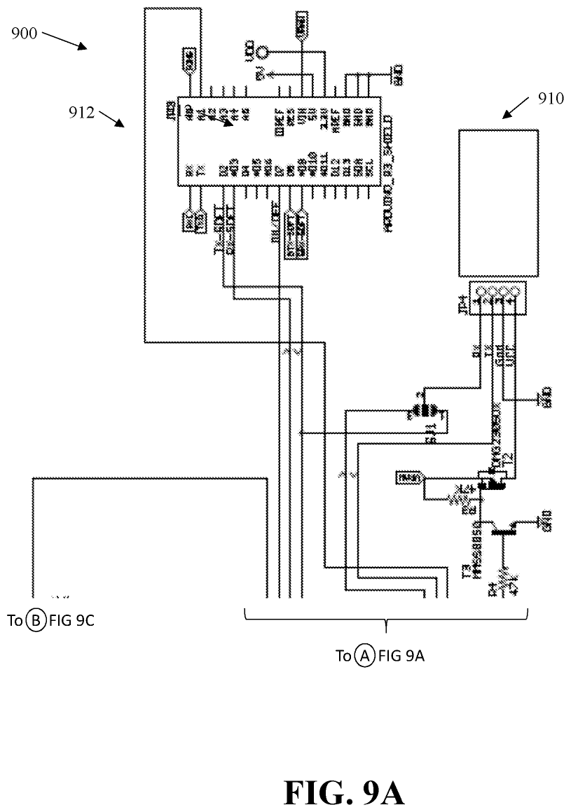

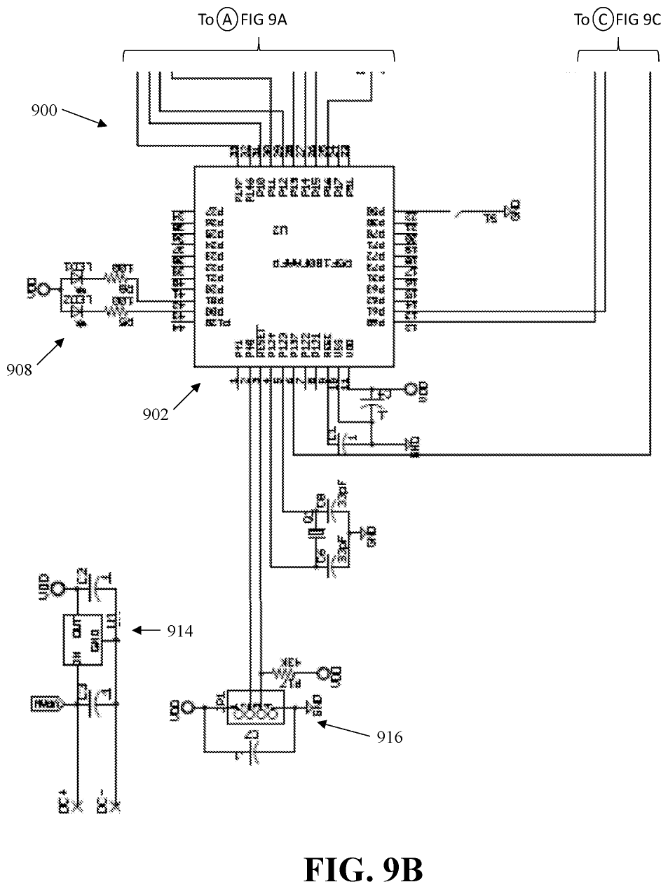

FIG. 9 is an schematic diagram of another exemplary self-learning level-sensor 900. FIGS. 9A-9C are enlarged portions of FIG. 9. The exemplary self-learning level-sensor 900 includes a processor 902, which in this embodiment is a microprocessor, distance sensor circuitry 904, indicator circuitry 908, wireless communication circuitry in the form of blue tooth circuitry 910 and cellular circuitry 612. Debugging connection port 916 is also included. Voltage regulator 914 provides power to the system. In this exemplary embodiment, two forms of wireless communications are used, however, in some embodiments, one form of wireless communication circuitry is used. In some embodiments, hard wired communications circuitry is used.

While various inventive aspects, concepts and features of the inventions may be described and illustrated herein as embodied in combination with exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A self-calibrating level sensor for a dispenser comprising:
a housing configured to be attached to a dispenser housing;
a transmitter;
a receiver;
a processor;
memory;
logic for causing the transmitter to transmit, and the receiver to receive, signals indicative of a plurality of levels of product in a dispenser;
logic for assigning a first level as an empty level;
logic for assigning a second level as a full level;
logic for assigning a third level as the empty level if the third level is less than the first level; and
logic for assigning a fourth level as the full level if the forth level is greater than the second level.

2. The self-calibrating level sensor of claim 1 further comprising a wireless transmitter for transmitting a signal indicative of a level to a host computer.

3. The self-calibrating level sensor of claim 1 wherein the dispenser is a paper towel dispenser.

4. The self-calibrating level sensor of claim 1 wherein the dispenser is a toilet paper dispenser.

5. The self-calibrating level sensor of claim 1 wherein the dispenser is a soap dispenser.

6. The self-calibrating level sensor of claim 1 wherein the dispenser is a trash receptacle.

7. The self-calibrating level sensor of claim 1 further comprising a display for displaying a level.

8. A self-calibrating level sensor for a dispenser comprising:
a housing;
a transmitter;
a receiver;
a processor;
memory;
logic for causing the transmitter to transmit, and the receiver to receive, signals indicative of a plurality of levels of product in a dispenser;
logic for assigning a first level as an empty level;
logic for assigning a second level as a full level;
logic for assigning a third level as the empty level if the third level is less than the first level; and
logic for assigning a fourth level as the full level if the forth level is greater than the second level; and
wireless communication circuitry for transmitting a signal indicative of a level of product in the dispenser.

9. The self-calibrating level sensor of claim 8 further comprising logic for decreasing the full level value after a period of time.

10. The self-calibrating level sensor of claim 8 wherein the transmitter transmits an infrared signal.

11. The self-calibrating level sensor of claim 8 wherein the transmitter transmits an ultrasonic signal.

12. A restroom system comprising:
a first product dispenser for dispensing a first product;
a second product dispenser for dispensing a second product;
wherein the first product is different than the second product;
a first self-calibrating level sensor in the first dispenser;
the first self-calibrating level sensor including
a housing configured to be attached to the dispenser for dispensing the first product;
a transmitter;
a receiver;
a processor;
memory;
logic for causing the transmitter to transmit, and the receiver to receive, signals indicative of a plurality of levels of product in a dispenser;
logic for assigning a first level as an empty level;
logic for assigning a second level as a full level;
logic for assigning a third level as the empty level if the third level is less than the first level; and
logic for assigning a fourth level as the full level if the forth level is greater than the second level;
a second self-calibrating level sensor in the second dispenser, wherein the second self-calibrating level sensor comprises substantially the same components as the first self-calibrating sensor and the housing of the second self-calibrating level sensor is configured to attach to the housing of the second product dispenser.

13. The restroom system of claim 12 wherein the first self-calibrating level sensors further comprise wireless communication circuitry for transmitting a level to a remote computer.

14. The restroom system of claim 12 wherein the second self-calibrating level sensors further comprise wireless communication circuitry for transmitting a level to a remote computer.

15. The restroom system of claim 12 further comprising a communications gateway for receiving signals from one or more dispenser and for transmitting one or more signals indicative of a level.

16. The restroom system of claim 15 wherein the self-calibrating level sensor is configured to transmit a signal indicative of a dispenser identifier that identifies a dispenser that correlates to the one or more signals indicative of a level.

17. The restroom system of claim 12 further comprising a remote terminal for displaying a level of product in a dispenser.

18. The restroom system of claim 12 further comprising a local terminal for displaying a level of product in a dispenser.

19. The restroom system of claim 18 wherein the local terminal is located on a dispenser.

20. The restroom system of claim 18 wherein the local terminal is located proximate the restroom.
